(19) United States
(12) Patent Application Publication
(10) Pub. No.: US 2006/0051655 A1
(43) Pub. Date: Mar. 9, 2006

(54) Fuel cell, electrode for fuel cell, and method producing them

(76) Inventors: Tsutomu Yoshitake, Tokyo (JP); Shin Nakamura, Tokyo (JP); Hidekazu Kimura, Tokyo (JP); Sadanori Kuroshima, Tokyo (JP); Yuichi Shimakawa, Tokyo (JP); Takashi Manako, Tokyo (JP); Hideto Imai, Tokyo (JP); Yoshimi Kubo, Tokyo (JP)

Correspondence Address: SUGHRUE MION, PLLC, 2100 PENNSYLVANIA AVENUE, N.W., SUITE 800, WASHINGTON, DC, 20037, US

(21) Appl. No.: 10/519,105

(22) PCT Filed: Jun. 23, 2003
(86) PCT No.: PCT/JP03/07981

§ 371 Date: Dec. 23, 2004

(30) Foreign Application Priority Data
Jun. 24, 2002 (JP) 2002-183412

(51) Int. Cl. H01M 4/86; H01M 4/90; H01M 4/92; H01M 8/10; B05D 5/12; H01M 4/88

(52) U.S. Cl. 429/40; 429/44; 429/32; 502/101; 427/115

(57) ABSTRACT

The present invention provides a fuel cell which is small-sized and light-weight for mounting in a mobile device, and has a high output-density. A current-collector 421 of a fuel electrode (or a current-collector 423 of an oxidizer electrode) is bonded to a substrate 104 (or a substrate 110) of a fuel electrode 102 (or an oxidizer electrode 108) in a fuel cell 100, rendering the current-collector 421 (or the current-collector 423) to be thin and light-weight, and making it no longer necessary to use an end plate and a fastener. Fuel or oxidizer is supplied directly to a surface of the current-collector 421 or 423.

### FIELD OF THE INVENTION

The invention relates to a fuel cell, an electrode used for a fuel cell, and a method of fabricating them.

### PRIOR ART

With recent realization of computerized society, an electronic device such as a personal computer has to deal with a significantly increased amount of data, resulting in remarkable increase in power consumption of an electronic device. In particular, a mobile electronic device is now urgently required to have a countermeasure to an increase in power consumption caused by an increase in capacity for dealing with data.

A mobile electronic device is currently generally designed to have a lithium ion cell as a power source. However, an energy density of a lithium ion cell now almost reaches an upper theoretical limit. Hence, in order to prolong a duration for continuously use a mobile electronic device, it was necessary to lower a frequency at which a central processing unit (CPU) is driven for reducing power consumption.

Under such circumstances, an attempt of using a fuel cell having a high energy density and a high heat exchanger effectiveness in place of a lithium ion cell as a power source for an electronic device has been made to significantly prolong a duration for continuously using a mobile electronic device.

A fuel cell is comprised generally of a fuel electrode, an oxidizer electrode, and an electrolyte sandwiched between the fuel and oxidizer electrodes. Fuel is supplied to a fuel electrode, and oxidizer is supplied to an oxidizer electrode, resulting in that electric power is electrochemically generated. As fuel, hydrogen is generally used. In recent years, since methyl alcohol is cheap and is easy to handle, there are now being developed a methyl alcohol reformation type fuel cell in which methyl alcohol is reformed to generate hydrogen, and a direct methyl alcohol solid electrolyte type fuel cell in which methyl alcohol is supplied directly to a fuel cell as fuel.

In a fuel cell using hydrogen as fuel, a reaction in a fuel electrode occurs in accordance with the following reaction formula (1).
3H₂→6H⁺+6e⁻ (1)

In a fuel cell using methyl alcohol as fuel, a reaction in a fuel electrode occurs in accordance with the following reaction formula (2).
CH₃OH+H₂O→6H⁺+CO₂+6e⁻ (2)

In a fuel cell using hydrogen or methyl alcohol as fuel, a reaction in an oxidizer electrode occurs in accordance with the following reaction formula (3).
(3/2)O₂+6H⁺+6e⁻→3H₂O (3)

In particular, in a direct methyl alcohol solid electrolyte type fuel cell, since hydrogen ions can be obtained from aqueous solution of methyl alcohol, it is no longer necessary for a fuel cell to prepare a reformer, ensuring that a fuel cell can be fabricated in a small-size and light-weight. Thus, there is obtained a big advantage in application of a direct methyl alcohol solid electrolyte type fuel cell to a mobile electronic device. In addition, since aqueous solution of methyl alcohol in the form of liquid is used as fuel, a direct methyl alcohol solid electrolyte type fuel cell can have a quite high energy density.

In a direct methyl alcohol solid electrolyte type fuel cell, a unit cell generates a voltage equal to or smaller than 1V. Accordingly, it is necessary to connect a plurality of unit cells in series to one another for generating a high voltage in a case where a direct methyl alcohol solid electrolyte type fuel cell is applied to a mobile device such as a mobile phone. A fuel cell to be used for an automobile or a domestic fuel cell is generally designed to have a stack structure in which a plurality of unit cells are vertically connected to one another. In contrast, when a direct methyl alcohol solid electrolyte type fuel cell is used for a mobile device, a plurality of direct methyl alcohol solid electrolyte type fuel cells are often connected to one another in a plane because of limitation of a thickness of the mobile device.

A conventional fuel cell is designed to include a plurality of unit cells arranged in a plane. Each of the unit cells includes a fuel electrode and an oxidizer electrode arranged on opposite surfaces of a solid electrolyte film, respectively. In each of the unit cells, current-collectors make electrical contact with a fuel electrode and an oxidizer electrode. The unit cells are electrically connected to one another through the current-collector. Specifically, each of the unit cells includes a fuel electrode end plate and an oxidizer electrode end plate both arranged outermost of the unit cell. By applying a constant pressure to the fuel and oxidizer electrodes by means of a fastener such as a bolt and a nut, the fuel and oxidizer electrodes are caused to make electrical contact with the current-collectors to thereby have desired output characteristic. Fuel is supplied to the unit cell from an external fuel reservoir and exhausted from the unit cell through a fuel channel formed in the fuel electrode end plate.

For instance, Japanese Patent Application Publications Nos. 2000-513480, 8-167416, 8-162123, and 8-106915 have suggested a solid electrolyte type fuel cell to be used for a mobile device. FIG. 2 illustrates an example of a structure of a conventional solid electrolyte type fuel cell to be used for a mobile device.

The conventional solid electrolyte type fuel cell illustrated in FIG. 2 is comprised of a fuel electrode 102, an oxidizer electrode 108, and a solid electrolyte film 114 sandwiched between the fuel electrode 102 and the oxidizer electrode 108.

The fuel electrode 102 is comprised of a substrate 104, a catalyst layer 106 arranged on one of surfaces of the substrate 104, and a fuel-electrode current-collector 421 arranged on the other surface of the substrate 104. The oxidizer electrode 108 is comprised of a substrate 110, a catalyst layer 112 arranged on one of surfaces of the substrate 110, and an oxidizer-electrode current-collector 423 arranged on the other surface of the substrate 110.

The fuel electrode 102 and the oxidizer electrode 108 are arranged such that the catalyst layers 106 and 112 face each other with the solid electrolyte film 114 being sandwiched therebetween. The fuel cell generates a current and outputs the current through the fuel-electrode current-collector 421 and the oxidizer-electrode current-collector 423.

A fuel-electrode end plate 120 is arranged in contact with the fuel-electrode current-collector 421, and an oxidizer-electrode end plate 122 is arranged in contact with the oxidizer-electrode current-collector 423. The fuel-electrode end plate 120 and the oxidizer-electrode end plate 122 are coupled to each other through a fastener 13 such as a bolt and a nut. By coupling the fuel-electrode end plate 120 and the oxidizer-electrode end plate 122 to each other through the fastener 13, a constant pressure is applied to the fuel-electrode current-collector 421 and the oxidizer-electrode current-collector 423, ensuring that the fuel-electrode current-collector 421 and the oxidizer-electrode current-collector 423 make contact with the substrate 104 and the substrate 110, respectively, with mechanically sufficient adhesive force.

It is necessary for the fuel-electrode end plate 120 and the oxidizer-electrode end plate 122 to have sufficient rigidity. If the rigidity is insufficient, the end plates 120 and 122 would be deformed when compressed through the fastener 13. The deformation of the end plates 120 and 122 would cause insufficient mechanical contact between the current-collectors 421, 423 and the substrates 104 and 110, resulting in an increase in an internal resistance of the fuel cell. Thus, the problem of reduction in output power of the fuel cell remains unsolved.

As mentioned above, a conventional fuel cell in which the end plates 120 and 122 are arranged on the fuel electrode 102 and the oxidizer electrode 108, respectively, and the current-collectors 421 and 423 are caused to make close contact with the substrates 104 and 110, respectively, by means of the fastener 13 such as a bolt and a nut, the end plates 120 and 122 are required to have sufficient rigidity in order to reduce an internal resistance of the fuel cell. If the parts of the fuel cell do not make close contact with each other, an internal resistance of the fuel cell would be increased, resulting in reduction in output power of the fuel cell.

For instance, if the end plates 120 and 122 are composed of bakelite or stainless steel, it would be necessary for the end plates 120 and 122 to have a thickness of 1 mm or greater in order to ensure sufficient rigidity to the end plates 120 and 122. This results in difficulty in fabricating a fuel cell to be thin and light-weighted.

In contrast, if the end plates 120 and 122 are designed to have a thickness of 0.5 mm or smaller, the end plates 120 and 122 would have reduced rigidity, resulting in that the end plates 120 and 122 would be deformed when the end plates 120 and 122 are coupled to each other through the fastener 13. This results in that a contact pressure among the fuel electrode, the oxidizer electrode and the solid electrolyte film is reduced, and thus, output power of the fuel cell is lowered.

Japanese Patent Application Publication No. 2001-283892 has suggested a fuel cell comprised of a plurality of unit cells connected to one another in a plane, as a fuel cell to be used for a mobile device. The suggested fuel cell includes a plurality of unit cells connected to one another in a plane. The unit cell is comprised of the fuel cell illustrated in FIG. 2. The suggested fuel cell includes end plates associated with the fuel and oxidizer electrodes. The end plates are coupled to each other through a bolt and a nut to ensure electrical contact among parts constituting the unit cell.

As mentioned above, in a conventional fuel cell, even when a fuel cell is comprised of a plurality of unit cells, it was necessary to cause parts constituting a unit cell to make close contact with one another by means of a fastener such as a bolt and a nut.

A fuel cell to be used in a mobile device is required to be thin, small in size, and light in weight. For instance, a mobile phone is light in weight, specifically, about 100 grams. Hence, a fuel cell is necessary to reduce a weight gram by gram and a thickness millimeter by millimeter. However, as mentioned earlier, the conventional fuel cell is accompanied with a problem that if fabricated small in size and light in weight, the fuel cell would have an increased internal resistance, and hence, output power of the fuel cell would be reduced.

As mentioned above, the conventional fuel cell is accompanied with a problem that the fuel cell cannot be fabricated thin and light-weighted, because the end plates are arranged to make contact with the fuel and oxidizer electrodes, and the fuel and oxidizer electrodes are caused to make sufficient close contact with each other through a fastener such as a bolt and a nut.

The conventional fuel cell is accompanied further with a problem that if the conventional fuel cell is fabricated thin and light-weighted by thinning the end plates, the parts constituting the fuel cell cannot make close contact with one another, resulting in an increase in an internal resistance and reduction in output power.

In particular, the conventional fuel cell is accompanied with a problem that an increase in output power is not compatible with fabrication of the fuel cell to be thin, small and light-weighted for the purpose of application to a mobile device.

In view of the above-mentioned problems in the conventional fuel cell, it is an object of the present invention to provide a fuel cell capable of outputting high power and being fabricated to be thin, small, and light-weighted.

Another object of the present invention is to provide a fuel cell sufficiently small and light-weighted to apply to a mobile device, and having a high power density.

### DISCLOSURE OF THE INVENTION

The present invention provides an electrode used for a fuel cell, comprising a substrate, a current-collector arranged on one of surfaces of the substrate, and a catalyst layer arranged on the other surface of the substrate, characterized in that the current-collector and the substrate are bonded to each other.

The electrode used for a fuel cell, in accordance with the present invention has a structure in which a substrate and a current-collector are bonded to each other. Herein, the term “bonded” means, for instance, that a substrate and a current-collector make sufficient close contact without being coupled to each other by means of end plates and a fastener. Specifically, for instance, a substrate and a current-collector may be bonded to each other through an adhesive layer formed at an interface therebetween, bonded through brazing material, bonded through an adhesive layer having affinity to both a substrate and a current-collector, or bonded by forming alloy at an interface therebetween. As an alternative, a substrate and a current-collector may be bonded to each other by causing chemical reactions.

By bonding a substrate and a current-collector to each other, adhesion between the substrate and the current-collector is kept high, ensuring electrical connection of the substrate and the current-collector to each other. Hence, the electrode used for a fuel cell, in accordance with the present invention makes it no longer necessary to use parts which were necessary for coupling a substrate and a current-collector to each other, such as an end plate and a bolt and a nut, but which prevented a fuel cell from being fabricated small. Thus, the fuel cell in accordance with the present invention can be fabricated thin, small, and light-weighted.

The electrode used for a fuel cell, in accordance with the present invention does not include parts which were conventionally arranged outside of current-collectors of fuel and oxidizer electrodes, but which prevented a fuel cell from being fabricated small, such as an end plate, but may include parts which does not prevent a fuel cell from being fabricated small, such as packing material, if necessary.

A current-collector in a conventional fuel cell had to have such a thickness that the current-collector was not deformed, because the conventional fuel cell used an end plate and a fastener. Since the electrode in accordance with the present invention makes it no longer necessary to use an end plate and a fastener, it is possible to fabricate a current-collector thin.

It is preferable that the substrate contains carbon as a principal component in the electrode used for a fuel cell, in accordance with the present invention.

By designing the substrate to contain carbon as a principal component, it is possible to enhance electrical conductivity of the substrate. In addition, since the substrate and the current-collector can be bonded to each other by virtue of formation of metal carbide by appropriately selecting a material of which the current-collector is composed, it would be possible to enhance electrical connection between the substrate and the current-collector.

It is preferable that the current-collector contains an element which will make carbide, in the electrode used for a fuel cell, in accordance with the present invention.

By designing the current-collector to contain such an element, it would be possible to enhance affinity between the current-collector and the substrate when the substrate is designed to contain carbon as a principal component. As a result, the current-collector and the substrate can make further close contact with each other, ensuring enhancement in electrical connection between them. In addition, a fuel cell including the electrode in accordance with the present invention could output higher power.

When the substrate and current-collector are bonded to each other by forming metal carbide therebetween, it is preferable that the current-collector contains one or more element(s) selected from Ti, Zr, Hf, V, Nb, Ta, Cr, Mo, W, Mn, Fe, Co, Ni, Al and C.

Thus, since carbide is formed at an interface between the substrate and the current-collector, the substrate and the current-collector can make further close contact with each other.

The current-collector may be composed of electrically conductive metal or alloy thereof.

By composing the current-collector of electrically conductive metal or alloy thereof, it would be possible to reduce a contact resistance of the current-collector, and enhance a current-collection efficiency of the current-collector. Accordingly, a fuel cell including the electrode in accordance with the present invention could output higher power.

It is preferable that the current-collector contains one or more element(s) selected from Au, Ag, Cu and Pt, in the electrode used for a fuel cell, in accordance with the present invention.

By designing the current-collector to contain Au, Ag and/or Cu, it would be possible to reduce an electrical resistance of the current-collector, ensuring that the current-collector can be fabricated thinner. Accordingly, the electrode can be fabricated further thinner, smaller, and lighter in weight. Furthermore, by designing the current-collector to contain Au, Ag and/or Cu, the current-collector would be similar to noble metal with respect to characteristics, ensuring enhancement in corrosion-resistance of the current-collector.

The current-collector may be comprised of a metal plate or a metal mesh in the electrode used for a fuel cell, in accordance with the present invention.

When the current-collector is comprised of a metal plate, it is preferable that the metal plate is formed with a channel through which fuel or oxidizer is introduced into the fuel and oxidizer electrodes, respectively. For instance, there may be used a metal plate formed with a through-hole, a porous metal plate, or a metal plate formed with a linear hole. When the current-collector is comprised of a metal mesh, there may be used a porous metal mesh such as a gold mesh, for instance. By designing the current-collector to be comprised of a metal plate or a metal mesh, it would be possible to facilitate gas or liquid to spread between the substrate and the current-collector. In addition, it would be also possible to fabricate the current-collector light-weighted. Hence, a fuel cell including the electrode in accordance with the present invention can be fabricated light-weighted.

It is preferable that the current-collector has a thickness equal to or greater than 0.05 mm, but equal to or smaller than 1 mm in the electrode used for a fuel cell, in accordance with the present invention.

By designing the current-collector to have a thickness equal to or greater than 0.05 mm, it would be possible to reduce an electrical resistance of the current-collector in a thickness-wise direction thereof. By designing the current-collector to have a thickness equal to or smaller than 1 mm, it would be possible to fabricate the current-collector thinner, smaller, and lighter in weight. Accordingly, a fuel cell including the electrode in accordance with the present invention can output higher power, and can be fabricated thinner, smaller, and lighter in weight.

The present invention provides a fuel cell comprising a fuel electrode, an oxidizer electrode, and a solid electrolyte film sandwiched between the fuel electrode and the oxidizer electrode, characterized in that one of the fuel electrode and the oxidizer electrode is comprised of the above-mentioned electrode.

Since the substrate and the current-collector in each of the fuel and oxidizer electrodes are bonded to each other in the fuel cell in accordance with the present invention, it is possible to keep the substrate and the current-collector in close contact with each other without an end plate and a fastener, keeping sufficient electrical contact between the substrate and the current-collector. Accordingly, the fuel cell can be fabricated thin, small and light-weighted.

The fuel cell in accordance with the present invention may be in any form. For instance, the fuel cell may be planar or cylindrical.

The fuel electrode may be comprised of the electrode, and fuel may be supplied directly to a surface of the current-collector of the electrode in the fuel cell in accordance with the present invention.

The fuel electrode in the fuel cell in accordance with the present invention has a structure in which the substrate is arranged on the current-collector, and the catalyst layer is formed on the substrate. The structure makes it possible to keep the substrate and the current-collector in the fuel electrode in close contact with each other without an end plate and a fastener, keeping sufficient electrical contact between the substrate and the current-collector.

In the fuel cell in accordance with the present invention, fuel is supplied directly to a surface of the current-collector in the fuel electrode.

Fuel can be supplied directly to a surface of the current-collector in the fuel electrode, for instance, by arranging a fuel reservoir or a fuel supplier on the current-collector of the fuel electrode. Thus, fuel can be supplied to the current-collector of the fuel electrode without a part such as an end plate.

Accordingly, the fuel cell in accordance with the present invention can be fabricated thinner, smaller, and lighter in weight and have superior output characteristic, because fuel is supplied directly to a surface of the current-collector in the fuel electrode without a part which prevents the fuel cell from being fabricated small, such as an end plate.

When the current-collector is designed in the form of a plate, it is preferable that the current-collector is formed with a through-hole through which fuel is supplied to the current-collector. This ensures that fuel is supplied efficiently to the fuel cell through a surface of the current-collector. Furthermore, the fuel cell in accordance with the present invention may include a part which does not prevent the fuel cell from being fabricated small, such as a packing material.

The fuel electrode may be comprised of the electrode, and the fuel cell may further include a fuel reservoir or a fuel channel making contact with a surface of the current-collector of the electrode for supplying fuel to the fuel electrode.

Since the fuel electrode in the fuel cell in accordance with the present invention has a structure in which the substrate is arranged on the current-collector, and the catalyst layer is formed on the substrate, the substrate and the current-collector are kept in sufficient electrical contact with each other. Furthermore, in the fuel cell in accordance with the present invention, a fuel supply for supplying fuel to the fuel electrode, such as a fuel reservoir or a fuel channel, is formed in contact with a surface of the current-collector of the fuel electrode without a part which prevents the fuel cell from being fabricated small, such as an end plate. Fuel is supplied directly to a surface of the current-collector of the fuel electrode. Accordingly, the fuel cell in accordance with the present invention is thin, small, and light-weighted, and has superior output characteristic.

When the current-collector is in the form of a plate, the current-collector may be formed at a surface thereof with a through-hole or a striped channel. This ensures that fuel is efficiently supplied into the substrate of the fuel electrode through a surface of the current-collector. Furthermore, the fuel cell in accordance with the present invention may include a part which does not prevent the fuel cell from being fabricated small, such as a packing material.

The oxidizer electrode may be comprised of the electrode, and an oxidizer may be supplied directly to a surface of the current-collector of the electrode.

The oxidizer electrode in the fuel cell in accordance with the present invention has a structure in which the substrate is arranged on the current-collector, and the catalyst layer is formed on the substrate. The structure makes it possible to keep the substrate and the current-collector in the oxidizer electrode in close contact with each other without an end plate and a fastener, keeping sufficient electrical contact between the substrate and the current-collector. In the fuel cell in accordance with the present invention, oxidizer is supplied directly to a surface of the current-collector in the oxidizer electrode. Herein, the passage “oxidizer is supplied directly” means that oxidizer gas is absorbed directly through a surface of the current-collector of the oxidizer electrode, that is, oxidizer is supplied to the current-collector of the oxidizer electrode not through an end plate or a separator.

Accordingly, the fuel cell in accordance with the present invention can be fabricated thinner, smaller, and lighter in weight and have superior output characteristic, because oxidizer is supplied directly to a surface of the current-collector in the oxidizer electrode without a part which prevents the fuel cell from being fabricated small, such as an end plate.

When the current-collector is designed in the form of a plate, it is preferable that the current-collector is formed with a through-hole through which oxidizer is supplied to the current-collector. This ensures that oxidizer is supplied efficiently to the fuel cell through a surface of the current-collector. Furthermore, the fuel cell in accordance with the present invention may include a part which does not prevent the fuel cell from being fabricated small, such as a packing material.

The current-collector of the electrode defining the oxidizer electrode may be designed to make direct contact at a surface thereof with atmosphere.

Since the oxidizer electrode in the fuel cell in accordance with the present invention has a structure in which the substrate is arranged on the current-collector, and the catalyst layer is formed on the substrate, the substrate and the current-collector are kept in sufficient electrical contact with each other. Accordingly, oxidizer existing in atmosphere is supplied directly to a surface of the current-collector of the oxidizer electrode without a part which prevents the fuel cell from being fabricated small, such as an end plate. Thus, the fuel cell in accordance with the present invention is thin, small, and light-weighted, and has superior output characteristic.

It is preferable that the current-collector is packed at a surface thereof with a packing material in the fuel cell in accordance with the present invention.

In the fuel cell in accordance with the present invention, since the substrate and the current-collector in each of the fuel and oxidizer electrodes are bonded to each other, the substrate and the current-collector are kept in desired electrical contact to each other. Accordingly, by packing the current-collector at a surface thereof with a packing material, it would be possible to provide a fuel cell thin, small, and light-weighted and having superior output characteristic. For instance, it is no longer necessary to keep the substrate and the current-collector in electrical contact with each other by means of a part which prevents the fuel cell from being fabricated small, such as an end plate.

For instance, organic liquid fuel is supplied to the fuel electrode.

In the fuel cell in accordance with the present invention, the substrate and the current-collector in each of the fuel and oxidizer electrodes are bonded to each other. Hence, even if organic liquid fuel is supplied to the fuel electrode through a reservoir or a channel, the reservoir or channel may be arranged in direct contact with the current-collector of the fuel electrode not through an end plate. Thus, the fuel cell can be fabricated thin, small, and light-weighted.

The present invention provides a fuel cell comprising a plurality of unit cells wherein unit cells disposed adjacent to each other are connected with one another through a connection electrode, characterized in that each of the unit cells is comprised of the above-mentioned fuel cell.

The above-mentioned fuel cell (unit cell) in accordance with the present invention can be fabricated thin, small, and light-weighted and have superior output characteristic, because the current-collector and the substrate in each of the fuel and oxidizer electrodes are bonded to each other. By electrically connecting a plurality of the above-mentioned fuel cells (unit cells) in series and/or in parallel to one another to thereby define a single fuel cell, the single fuel cell can be thin, small, and light-weighted, and have superior output characteristic.

When a plurality of the unit cells are electrically connected to one another to thereby define a single fuel cell, though each of the unit cells may be designed to have a solid electrolyte film, it is preferable that a plurality of the unit cells have a common solid electrolyte film.

By designing the unit cells to have a common solid electrolyte film, it would be possible to reduce the number of parts and simplify fabrication steps in a process of connecting a plurality of unit cells to one another to define a single fuel cell.

The present invention provides a fuel cell comprising a cylindrical fuel reservoir, and a plurality of unit cells, characterized in that each of the unit cells is comprised of the above-mentioned fuel cell, and the fuel electrode of each of the unit cells is arranged on at least one of outer and inner surfaces of the fuel reservoir.

The fuel cell may further include a connection electrode through which unit cells disposed adjacent to each other are connected to each other.

The plurality of unit cells may be designed to have a common solid electrolyte film.

The present invention provides a method of fabricating a fuel cell comprising a substrate, a current-collector arranged on one of surfaces of the substrate, and a catalyst layer arranged on the other surface of the substrate, including a first step of coating a solution containing both particles containing solid polymer electrolyte and carbon particles carrying at catalyst, onto one of surfaces of the substrate for forming the catalyst layer, and a second step of bonding the substrate at the other surface thereof to the current-collector.

Since the method of fabricating a fuel cell, in accordance with the present invention includes the step of bonding the substrate and the current-collector to each other, they can make close contact with each other. This ensures that enhancement in electrical contact between the substrate and the current-collector without an end plate and a fastener. Thus, the method of fabricating a fuel cell, in accordance with the present invention makes it possible to fabricate a fuel cell which outputs high power and which is fabricated thin, small, and light-weighted.

In the method of fabricating a fuel cell, in accordance with the present invention, the substrate and the current-collector may be bonded to each other by thermal compression in the second step.

For instance, if the substrate contains metal which can make carbide, and the current-collector contains carbon as a principal component, it would be possible to cause the substrate and the current-collector to make close contact with each other by thermally compressing them to each other. Thus, it is possible to enhance electrical contact between the substrate and the current-collector.

In the method of fabricating a fuel cell, in accordance with the present invention, the substrate and the current-collector may be bonded to each other by brazing in the second step.

For instance, if the substrate contains carbon as a principal component, and the current-collector contains metal which is unlikely to make carbide, it would be possible to cause the substrate and the current-collector to make close contact with each other by brazing them to each other. Thus, it is possible to enhance electrical contact between the substrate and the current-collector.

In the method of fabricating a fuel cell, in accordance with the present invention, it is preferable in the second step to select one or more brazing metals selected from a group consisting of Pd, Fe, Ti, Ni, Zr, Cd and Al.

By using brazing material(s) containing these elements, it is possible to cause the substrate and the current-collector to make close contact to each other.

In the method of fabricating a fuel cell, in accordance with the present invention, the substrate may contain carbon as a principle component, the current-collector may contain metal, and the second step may be comprised of a step of forming a bonding layer composed of metal carbide between the substrate and the current-collector.

For instance, if the substrate contains carbon as a principal component, and the current-collector contains metal which is unlikely to make carbide, it would be possible to cause the substrate and the current-collector to make close contact with each other by forming a bonding layer containing metal which can make carbide, between the substrate and the current-collector, because the bonding layer has high affinity to both the substrate and the current-collector. Thus, it is possible to enhance electrical contact between the substrate and the current-collector.

In the method of fabricating a fuel cell, in accordance with the present invention, the bonding layer may contain one or more elements selected from a group consisting of Ti, Zr, Hf, V, Nb, Ta, Cr, Mo, W, Mn, Fe, Co, Ni and Al.

These elements are known as metals which react with carbon to thereby form carbide. Hence, if the substrate contains carbon as a principal component, it would be possible to enhance affinity between the substrate and the bonding layer by designing the bonding layer to contain the above-mentioned elements. Accordingly, it is possible to cause the substrate and the current-collector to make further close contact with each other, and hence, it is possible to enhance electrical contact between the substrate and the current-collector.

The present invention provides a method of fabricating a fuel cell, comprising the steps of fabricating an electrode in accordance with the above-mentioned method, and compressing the solid electrolyte film and the electrode to each other with the solid electrolyte film and the electrode being kept to make contact with each other, for bonding the solid electrolyte film and the electrode to each other.

Since the method of fabricating a fuel cell, in accordance with the present invention includes the step of fabricating the electrode in accordance with the present invention, the method naturally includes the step of bonding the substrate and the current-collector in each of the fuel and oxidizer electrodes to each other. Accordingly, it is possible to keep the substrate and the current-collector in close contact with each other without an end plate and a fastener, and hence, there is provided a method of fabricating a fuel cell, which is capable of fabricating a fuel cell which outputs high power, and is thin, small, and light-weighted. In addition, the method of fabricating a fuel cell, in accordance with the present invention simplifies fabrication steps, because the method makes it no longer necessary to carry out a step of fastening a substrate, a current-collector, and a catalyst layer to one another by means of an end plate and the like.

### BRIEF DESCRIPTION OF THE DRAWINGS

FIG. 1 is a schematic cross-sectional view of a fuel cell in accordance with the first embodiment of the present invention.

FIG. 2 is a perspective view illustrating an example of a conventional fuel cell.

FIG. 3 is a schematic cross-sectional view of a fuel cell in accordance with the second embodiment of the present invention.

FIG. 4 is a schematic cross-sectional view of a fuel cell in accordance with the third embodiment of the present invention.

FIG. 5 is a schematic perspective view of a fuel cell in accordance with the fourth embodiment of the present invention.

### INDICATION BY REFERENCE NUMERALS

8 Outer output terminal
9 Outer output terminal
100 Fuel cell
101 Unit cell
102 Fuel electrode
104 Substrate
106 Catalyst layer
108 Oxidizer electrode
110 Substrate
112 Catalyst layer
114 Solid electrolyte film
421 Current-collector of the fuel electrode
423 Current-collector of the oxidizer electrode
425 Fuel reservoir
427 Connection electrode
429 Seal
431 Package

### DETAILED DESCRIPTION OF THE PREFERRED EMBODIMENTS

Hereinbelow, the electrode used for a fuel cell, and the fuel cell including the electrode, both in accordance with the present invention, are explained with reference to drawings.

### First Embodiment

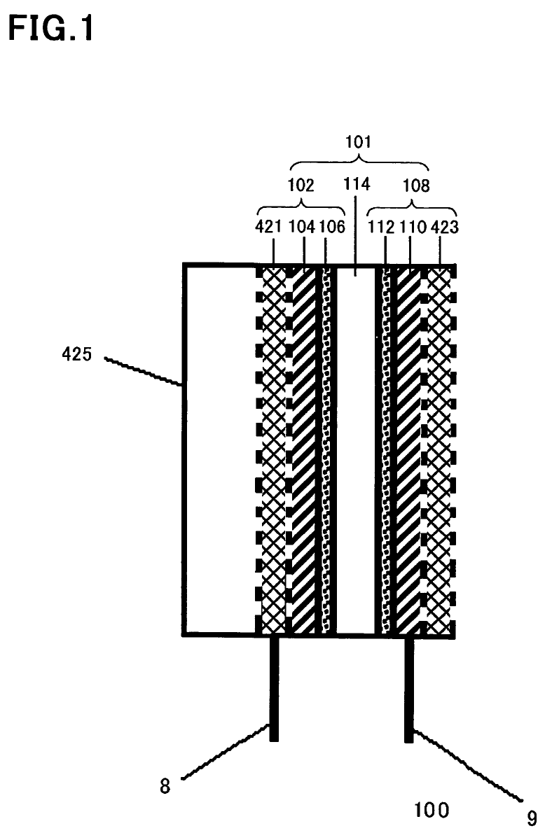

FIG. 1 is a schematic cross-sectional view of a unit cell 101 in a fuel cell 100 in accordance with the first embodiment of the present invention.

Though the fuel cell 100 in accordance with the first embodiment includes the single unit cell 101, the fuel cell 100 may be designed to include a plurality of the unit cells 101.

As illustrated in FIG. 1, the unit cell 101 is comprised of a fuel electrode 102, an oxidizer electrode 108, and a solid electrolyte film 114 sandwiched between the fuel electrode 102 and the oxidizer electrode 108 (a pair of the fuel electrode 102 and the oxidizer electrode 108 is called “catalyst electrodes”).

The fuel electrode 102 is comprised of a substrate 104, a catalyst layer 106 arranged on one of surfaces of the substrate 104, and a current-collector 421 arranged on the other surface of the substrate 104. The oxidizer electrode 108 is comprised of a substrate 110, a catalyst layer 112 arranged on one of surfaces of the substrate 110, and a current-collector 423 arranged on the other surface of the substrate 110.

The catalyst layers 106 and 112 may be designed to contain both carbon particles carrying at catalyst, and particulates of solid polymer electrolyte. The substrates 104 and 110 may be designed to be water-repellent at surfaces thereof.

The fuel cell 100 in accordance with the first embodiment includes a fuel reservoir 425 and two outer output terminals 8 and 9 apart from the unit cell 101.

The fuel reservoir 425 makes contact with the current-collector 421 of the fuel electrode 102, and supplied fuel to the fuel electrode 102. Oxygen in atmosphere is supplied to the oxidizer electrode 108 as oxidizer.

Electric power generated by the fuel cell 100 is output through the outer output terminals 8 and 9.

A fuel cell to be applied to a mobile device is required to be small, thin, and light-weighted, as well as to have high energy density and output density as basic functions. Thus, the first embodiment is characterized in that the substrates 104 and 110 are integral with the current-collectors 421 and 423 by bonding an electrically conductive material which will make the current-collectors 421 and 423, to the substrates 104 and 110, respectively. This ensures that the current-collectors 421 and 423 can make sufficient electrical contact with the substrates 104 and 110, respectively, even if an electrically conductive material which will make the current-collectors 421 and 423 is equal to or smaller than 1 mm, or equal to or smaller than 0.1 mm. Hence, it is possible to fabricate the unit cell 101 to be thin, for instance, to have a thickness equal to or smaller than 1 mm, ensuring the unit cell to have superior output characteristic.

The current-collectors 421 and 423 may be composed of an electrically conductive material such as metal or carbon.

The current-collectors 421 and 423 may be designed to contain one or more element(s) selected from a group consisting of Ti, Zr, Hf, V, Nb, Ta, Cr, Mo, W, Mn, Fe, Co, Ni, Al and C, for instance. Since those elements can make carbide, it is considered that they have preferable affinity with the substrates 104 and 110.

When the current-collectors 421 and 423 are designed to contain carbide of the above-mentioned element(s), it is preferable to select from Ti, Zr, Hf, V, Nb and Ta, because carbide of them has a relatively small electrical resistance.

The current-collectors 421 and 423 may be designed to contain one or more element(s) selected from a group consisting of Au, Ag, Cu and Pt. Since Au, Ag and Cu have a relatively small electrical resistance, it is possible to fabricate the current-collectors 421 and 423 thinner. Furthermore, since Au, Ag and Pt are noble metals, the current-collectors 421 and 423 containing one of them could have an enhanced corrosion-resistance.

The current-collectors 421 and 423 may be comprised of a thin plate formed with a through-hole or through-holes through which fuel or air (in particular, oxygen) passes. For instance, the current-collectors 421 and 423 may be comprised of a porous metal plate. As an alternative, the current-collectors 421 and 423 may be comprised of a metal mesh in place of a thin plate. Since it is possible to supply fuel or oxidizer directly to the current-collectors 421 and 423 comprised of a metal mesh, through surfaces thereof, the fuel cell 100 can be fabricated thinner, smaller, and lighter in weight.

When the current-collectors 421 and 423 are comprised of a porous metal plate or a metal mesh, apertures may be designed to have a diameter equal to or greater than 0.1 mm, but equal to or smaller than 5 mm, for instance. By designing the apertures to have such a diameter, it would be possible to keep fuel liquid or fuel gas spread in a preferable manner.

An aperture ratio (a ratio of a total area of apertures to a total area of a surface of a current-collector) of the current-collectors 421 and 423 may be designed to be equal to or greater than 10%, for instance. By designing the aperture ratio to be equal to or greater than 10%, it would be possible to keep fuel liquid or fuel gas spread in a preferable manner. It is preferable that the aperture ratio is equal to or smaller than 70%. By designing the aperture ratio to be equal to or smaller than 70%, the current-collector can keep its function of collecting current desired.

For instance, the current-collectors 421 and 423 may be designed to have a thickness of 1 mm or smaller. By designing the current-collectors 421 and 423 to have a thickness of 1 mm or smaller, it would be possible to fabricate the unit cell 101 preferably thin and light-weighted. In addition, by designing the current-collectors 421 and 423 to have a thickness of 0.5 mm or smaller, it would be possible to fabricate the unit cell 101 thinner and lighter in weight, ensuring that the fuel cell is applied preferably to a mobile device. For instance, the current-collectors 421 and 423 may be designed to have a thickness of 0.1 mm or smaller.

The current-collectors 421 and 423 may be composed of a common material, or different materials from each other.

The substrates 104 and 110 may be comprised of carbon paper, carbon mold, sintered carbon, or a porous substrate such as foam metal.

The substrates 104 and 110 may be designed to be water-repellent through the use of water-repellent agent such as polytetrafluoroethylene.

As catalyst for the fuel electrode 102, there may be used platinum, rhodium, palladium, iridium, osmium, ruthenium, rhenium, gold, silver, nickel, cobalt, lithium, lantern, strontium, and yttrium alone or in combination.

As catalyst for the oxidizer electrode 108, there may be used the same catalyst as those used for the fuel electrode 102. For instance, the above-mentioned elements may be used. The fuel electrode 102 and the oxidizer electrode 108 may use the same catalyst as each other, or may use different catalyst from each other.

As carbon particles carrying at catalyst, there may be used acetylene black (for instance, “Denka black” (registered trademark) commercially available from Denki-Kagakusha, or “XC72” commercially available from Vulcan), ketchen black, amorphous carbon, carbon nano-tube, or carbon nano-horn, for instance.

It is preferable for the carbon particles to have a diameter equal to or greater than 0.01 micrometer, but equal to or smaller than 0.1 micrometer, and it is more preferable for the carbon particles to have a diameter equal to or greater than 0.02 micrometers, but equal to or smaller than 0.06 micrometers.

The solid polymer electrolyte contained in the fuel and oxidizer electrodes 102 and 108 in the first embodiment has functions of electrically connecting carbon particles carrying at catalyst to the solid electrolyte film 114 in a surface of the catalyst electrodes, and transferring organic liquid fuel to a surface of catalyst. Hence, the solid polymer electrolyte is required to have hydrogen ion conductivity and water mobility. Furthermore, the solid polymer electrolyte contained in the fuel electrode 102 is required to allow organic liquid fuel such as methyl alcohol to pass therethrough, and the solid polymer electrolyte contained in the oxidizer electrode 108 is required to allow oxygen to pass therethrough.

In order to meet those requirements, the solid polymer electrolyte is selected from materials having hydrogen ion conductivity and permeability of organic liquid fuel such as methyl alcohol. Specifically, organic polymer having a polar group such as strong acid group (for instance, sulfonic group or phosphoric acid group) or weak acid group (for instance, carboxyl group) are preferably used as the solid polymer electrolyte. For instance, the followings may be used as the organic polymer.
(1) perfluorocarbon containing sulfonic group (for instance, Naphyon commercially available from Du Pont, or Athyplex commercially available from Asahi Kasei)
(2) perfluorocarbon containing carboxyl group (for instance, Flemion S film commercially available from Asahi Glass)
(3) copolymer containing copolymer of polystyrenesulfonic acid, copolymer of polyvinylsulfonic acid, derivative of cross-linked alkylsulfonic acid, skeleton of fluororesin and sulfonic acid (for instance, fluorine-containing polymer)
(4) copolymer resulted from copolymerization of acrylic amide such as acrylic amide-2-methylpropanesulfonic acid and acrylate such as n-butylmethacrylate

As polymer to which polar group is to be bonded, the followings may be used.
(1) resin containing nitrogen or hydroxyl group, such as polybenzimidazole derivative, polybenzoxazole derivative, cross-linked polyethyleneimine, polythyramine derivative, amine-substituted polystyrene such as polydiethylaminoethylpolystyrene, or nitrogen-substituted polyacrylate such as diethylaminoethylpolymethacrylate
(2) polyacryl resin containing hydroxyl group, such as polysiloxane containing silanol, or hydroxylethylpolymethylacrylate
(3) polystyrene resin containing hydroxyl group, such as parahydroxypolystyrene

Cross-linked substitutional group such as vinyl group, epoxy group, acrylic group, methacryl group, cinnamoyl group, methylol group, azide group, or naphthoquinonediazide group may be introduced into the above-mentioned polymers.

The fuel and oxidizer electrodes 102 and 108 may contain the same solid polymer electrolytes such as the above-mentioned ones, or different solid polymer electrolytes from each other.

The solid electrolyte film 114 separates the fuel electrode 102 from the oxidizer electrode 108, and transfers hydrogen ions between the fuel and oxidizer electrodes 102 and 108. Hence, it is preferable that the solid electrolyte film 114 is comprised of a film having high permeability of hydrogen ions. It is also preferable that the solid electrolyte film 114 is chemically stable, and has a high mechanical strength.

The solid electrolyte film 114 is composed preferably of organic polymer containing polar group such as strong acid group (for instance, sulfonic acid, phosphoric acid group, phosphon group or phosphine group), or weak acid group (for instance, carboxyl group). As such organic polymer, there may be used the followings, for instance.
(1) polymer containing aromatic compound, such as sulfonated poly (4-phenoxybenzoil-1,4-phenylene) or alkyl sulfonated polybenzoimidazole
(2) copolymer comprised of polystyrene sulfonic acid copolymer, polyvinyl sulfonic acid copolymer, cross-linked alkyl sulfonic acid derivative, skeleton of fluororesin and sulfonic acid, such as fluorine-containing polymer
(3) copolymer resulted from copolymerization of acrylic amide such as acrylic amide-2-methylpropane sulfonic acid and acrylate such as n-butylmethacrylate
(4) perfluorocarbon containing sulfonic group (for instance, Naphyon (registered trademark) commercially available from Du Pont, or Athyplex (registered trademark) commercially available from Asahi Kasei)
(5) perfluorocarbon containing carboxyl group (for instance, Flemion S film commercially available from Asahi Glass)

By selecting polymer containing aromatic compound, such as sulfonated poly (4-phenoxybenzoil-1,4-phenylene) or alkyl sulfonated polybenzoimidazole, it would be possible to inhibit organic liquid fuel to pass through the solid electrolyte film, preventing reduction in a cell efficiency, caused by crossover.

As fuel for the fuel cell 100 in accordance with the first embodiment, there may be used hydrogen, for instance. As an alternative, there may be used reformed hydrogen generated through the use of natural gas or naphtha as fuel. As an alternative, liquid fuel such as methyl alcohol may be supplied directly to the fuel cell, for instance. As oxidizer, there may be used oxygen or air, for instance.

In the fuel cell 100 in accordance with the first embodiment, fuel is supplied to the fuel electrode 102 through the fuel reservoir 425 bonded to the fuel electrode 102, as illustrated in FIG. 1, for instance. The fuel reservoir 425 is formed at a surface thereof facing the current-collector 421 of the fuel electrode 102, with a plurality of through-holes through which fuel is supplied to the current-collector 421 of the fuel electrode 102.

If necessary, the fuel reservoir 425 may be designed to have a fuel-supply inlet through which fuel is poured into the fuel reservoir 425. Fuel may be stored in the fuel reservoir 425, or may be transported to the fuel reservoir 425. That is, fuel may be supplied to the fuel cell not only from the fuel reservoir 425, but also through a fuel channel. For instance, fuel may be transported into the fuel reservoir 425 from a fuel cartridge.

The fuel cell 100 in accordance with the first embodiment and the electrodes 102 and 108 as components of the fuel cell 100 may be fabricated in accordance with any process. Hereinbelow is explained an example of a process of fabricating them.

For instance, the current-collectors 421 and 423 and the substrates 104 and 110 may be bonded to each other, respectively, by thermal compression under high temperature, brazing, or an adhesion layer to be sandwiched therebetween.

For instance, when the substrate 104 or 110 contains carbon as a principal component, and the current-collector 421 or 423 contains one or more element(s) selected from Ti, Zr, Hf, V, Nb, Ta, Cr, Mo, W, Mn, Fe, Co, Ni, Al and C, since these elements make carbide, the current-collector 421 or 423 may be bonded to the substrate 104 or 110 by thermally annealing the current-collector 421 or 423 at a temperature of 100 degrees centigrade or higher.

When the substrate 104 or 110 contains carbon as a principal component, and, for instance, the current-collector 421 or 423 is composed of either noble metal such as Au, Ag Cu or Pt, or a material which weakly chemically bonds to carbon or carbon-containing material, it would be possible to enhance adhesion between the substrate 104 or 110 and the current-collector 421 or 423 by sandwiching an adhesive layer between the substrate 104 or 110 and the current-collector 421 or 423.

Such an adhesive layer may contain metal which will make carbide, such as titanium or chromium, as a principal component, for instance.

For instance, as a method of bonding the substrates 104, 110 and the current-collectors 421, 423 to each other through an adhesive layer, there may be selected a method including the steps of evaporating metal having affinity to both the substrates 104, 110 and the current-collectors 421, 423, onto a surface of the substrates 104, 110 and/or the current-collectors 421, 423, causing the substrates 104, 110 and the current-collectors 421, 423 to make contact with each other through the evaporated metal, and thermally compressing the substrates 104, 110 and the current-collectors 421, 423 to each other.

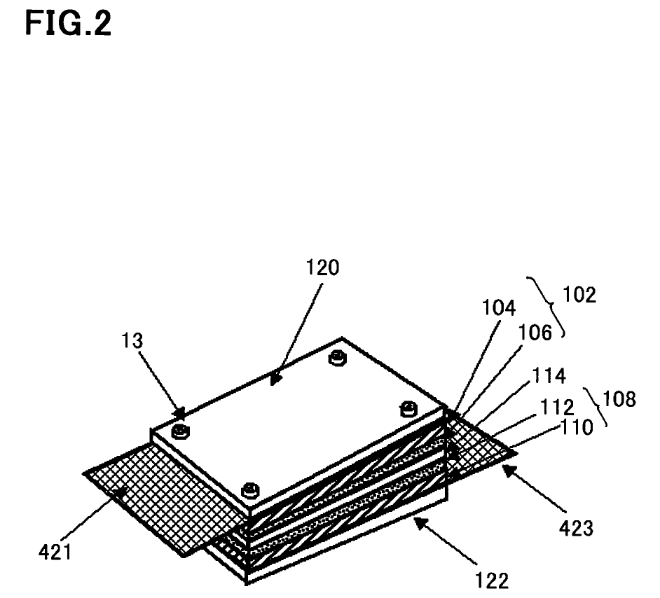

By bonding electrically conductive material of which the current-collectors 421 and 423 are composed, to the substrates 104 and 110, it would be possible to ensure desired electrical contact between the current-collectors 421, 423 and the substrates 104, 110 without application of mechanical pressure to them by means of the end plates 120 and 122, and the fastener 13, unlike the conventional fuel cell illustrated in FIG. 2.

The current-collectors 421, 423 and the substrates 104, 110 may be bonded to each other by brazing in place of sandwiching an adhesive layer therebetween.

Brazing material used for brazing the current-collectors and the substrates to each other preferably contains material having high affinity to metal contained in the current-collector 421 or 423, or metal having a relatively low melting point. As brazing material, there may be selected from Pd, Cu, Fe, Ti, Ni, Zr, Cd, or Al or alloy thereof, for instance, in accordance with materials of which the substrates 104, 110 and the current-collectors 421, 423 are composed. As an alternative, there may be selected from Cu—Ti, Cu—Ti—Zr, Ti—Ni, Ni—Cr—Si, Ni—Cr—B—Si—Fe, Pd—Ni—Mn or Pd—Ni—Cu—Mn brazing materials in accordance with materials of which the substrates 104, 110 and the current-collectors 421, 423 are composed.

As mentioned above, by bonding the current-collector 421 to the substrate 104, and the current-collector 423 to the substrate 110, respectively, the substrates 104 and 110 can keep close contact with the current-collectors 421 and 423, even if the current-collectors 421 and 423 are thin, for instance, have a thickness of 0.1 mm or smaller. Thus, it is possible to prevent an increase in an internal resistance.

Catalyst of the fuel and oxidizer electrodes 102 and 108 are carried at by carbon particles in accordance with conventional impregnation process.

The fuel electrode 102 and the oxidizer electrode 108 may be fabricated by dispersing carbon particles carrying at catalyst, and solid electrolyte into solvent to thereby make paste, coating the paste to the substrates 104 and 110, and drying the paste.

The carbon particles have a diameter equal to or greater than 0.01 micrometer, but equal to or smaller than 0.1 micrometer, for instance. The catalyst particles have a diameter equal to or greater than 1 nanometer, but equal to or smaller than 10 nanometers, for instance. The particles of the solid polymer electrolyte have a diameter equal to or greater than 0.05 micrometer, but equal to or smaller than 1 micrometer, for instance. A weight ratio between the carbon particles and the particles of the solid polymer electrolyte is in the range of 2:1 to 40:1, for instance. A weight ratio between water and solute in the paste is in the range of about 1:2 to about 10:1, for instance.

The paste may be coated onto the substrates 104 and 110 in any manner. For instance, the paste may be coated onto the substrates 104 and 110 with a brush, the paste may be sprayed onto the substrates 104 and 110, or the paste may be coated onto the substrates 104 and 110 in accordance with screen printing.

The paste has a thickness equal to or greater than 1 micrometer, but equal to or smaller than 2 millimeters, for instance. After coated, the paste is heated at a temperature for a period of time both of which are determined in dependence on fluororesin used. Thus, the fuel electrode 102 or the oxidizer electrode 108 is fabricated. A temperature at which the paste is heated and a period of time for which the paste is heated are determined in accordance with a material of which the paste is composed. For instance, the paste is heated at 100 to 250 degrees centigrade for 30 seconds to 30 minutes.

The solid electrolyte film 114 in the first embodiment may be fabricated in accordance with an appropriate process determined in dependence on a material of which the solid electrolyte film 114 is composed.

For instance, when the solid electrolyte film 114 is composed of organic polymer, the solid electrolyte film 114 may be fabricated by dissolving or dispersing organic polymer into solvent, casting the solvent onto a peeling sheet composed of polytetrafluoroethylene, for instance, and drying the solvent.

The thus fabricated solid electrolyte film 114 between the fuel electrode 102 and the oxidizer electrode 108, and thermally pressing the solid electrolyte film 14, to thereby have a bonding structure of the catalyst electrode and the solid electrolyte film. In the fabrication of the bonding structure, the solid electrolyte film 114 is arranged to make contact with surfaces of the catalyst layers of the fuel and oxidizer electrodes 102 and 108.

A temperature at which the thermal press is carried out is determined in accordance with a material of which the solid electrolyte film 114 is composed. If the solid electrolyte film 114 and solid polymer electrolyte formed on surfaces of the fuel and oxidizer electrodes 102 and 108 are composed of organic polymer having a softening point and glass transition, a temperature at which the thermal press is carried out may be beyond a softening point and a glass-transition temperature of the organic polymer. Specifically, a temperature at which the thermal press is carried out is equal to or greater than 100 degrees centigrade, but equal to or smaller than 250 degrees centigrade, a pressure at which the thermal press is carried out is equal to or greater than 1 kg/cm², but equal to or smaller than 100 kg/cm², and a period of time for which the thermal press is carried out is equal to or greater than 10 seconds, but equal to or smaller than 30 seconds.

The thus fabricated bonding structure of the catalyst electrodes and the solid electrolyte film defines the unit cell 101 illustrated in FIG. 1.

Thus, there is obtained the fuel cell 100 including the catalyst electrodes 102 and 108 having an adhesive layer formed on surfaces of carbon particles carrying at catalyst. The fuel cell 100 can output high power and has a resistance to long-time use, because the adhesive layer formed on surfaces of carbon particles provides a large contact area for catalyst, and hence, aggregation of catalyst is suppressed.

By designing the fuel cell 100 to have the electrodes 102 and 108 including the current-collectors 421, 423 and the substrates 104, 110 bonded to each other, respectively, the fuel cell 100 would have a reduced internal resistance, and have desired output characteristic.

In addition, the fuel cell 100 can be fabricated thin, small, and light-weighted, because the current-collector 421 of the fuel electrode is designed to make direct contact with a fuel channel or the fuel reservoir 425 without using the end plates 120 and 122 (see FIG. 2) for supplying fuel to the fuel electrode.

For instance, the current-collector 421 of the fuel electrode and the fuel reservoir may be adhered to each other through an adhesive having a resistance to fuel, or fixedly bonded to each other by means of a fastener such as a bolt and a nut.

When the current-collector 421 of the fuel electrode is designed to make contact with a fuel channel or the fuel reservoir 425, and fuel is supplied directly to an allover surface of the current-collector 421, it is preferable to uniformize fuel concentration in a plane defined by the fuel electrode 102. This ensures that the fuel cell 100 can have enhanced output characteristic, because moisture gradient in a plane defined by the fuel electrode 102 can be lowered.

Furthermore, since it is possible to allow the oxidizer electrode 108 to make direct contact with oxidizer or atmosphere without using the end plates 120 and 122 (see FIG. 2) for receiving oxidizer, the fuel cell 100 can be fabricated thinner, smaller, and lighter in weight. Oxidizer may be supplied to the current-collector 423 of the oxidizer electrode 108 through a packing material, if the packing material prevents the fuel cell from being fabricated small.

Since the fuel cell 100 in accordance with the first embodiment is light-weighted and small, and outputs high power, the fuel cell 100 is preferably used in a mobile terminal such as a mobile phone.

### Second Embodiment

A single fuel cell can be fabricated by electrically connecting a plurality of the fuel cells 100 as unit cells to one another.

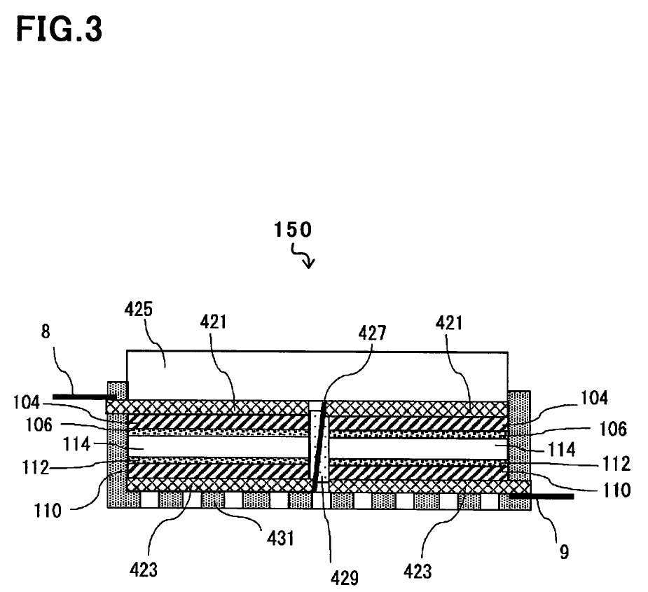

An example of such a single fuel cell is illustrated in FIG. 3.

A fuel cell 150 illustrated in FIG. 3 is comprised of two unit cells each comprised of the fuel cell 100 in accordance with the first embodiment, electrically connected in series to each other. The two unit cells are electrically connected to each other such that the current-collector 421 of one of the unit cells is electrically connected to the current-collector 423 of the other unit cell through a connection electrode 427. The connection electrode 427 is sealed with a seal 429 composed of electrically insulating material.

The two unit cells commonly have a single fuel reservoir 425. The two unit cells are packed with a package 431. Output terminals 8 and 9 extend from the current-collectors 421 and 423 which are not electrically connected to the connection electrode 427, through the package 431. The package 431 is formed at a bottom thereof with a plurality of apertures through which oxidizer is supplied to the oxidizer electrode 108.

Since the fuel cell 150 in accordance with the second embodiment, illustrated in FIG. 3, is comprised of the unit cells, that is, the fuel cells 100 in accordance with the first embodiment, the fuel cell 150 has the advantages provided by the first embodiment.

In the second embodiment, the fuel cell 150 is comprised of the two unit cells. However, the fuel cell 150 may be designed to be comprised of three or more unit cells.

It is possible to fabricate a fuel cell having desired capacity and voltage by electrically connecting a plurality of the fuel cells 100 in series and/or in parallel to one another. A plurality of the fuel cells 100 may be arranged in a plane, or may be arranged vertically in stack.

### Third Embodiment

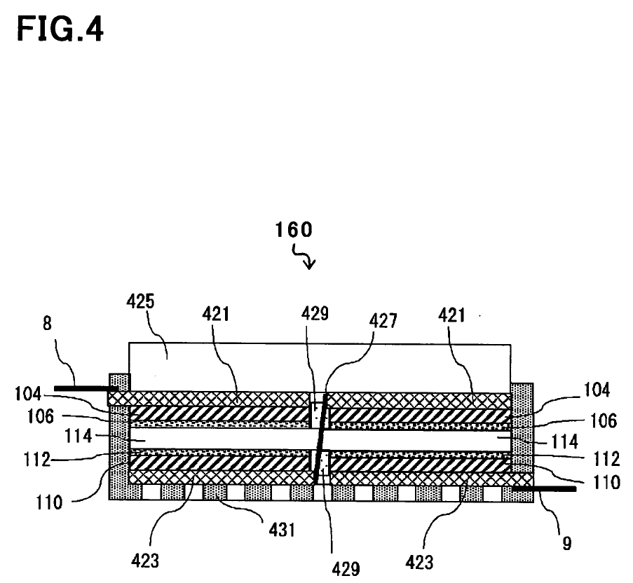

Another example of a fuel cell comprised of a plurality of unit cells each comprised of the fuel cell 100 in accordance with the first embodiment, electrically connected to one another is illustrated in FIG. 4 as the third embodiment.

Whereas each of the unit cells 100 in the fuel cell 150 illustrated in FIG. 3 is designed to individually have the solid electrolyte film 114, the two unit cells 100 defining the fuel cell 160 in accordance with the third embodiment, illustrated in FIG. 4, are designed to commonly have a single solid electrolyte film 114. The fuel cell 160 in accordance with the third embodiment has the same structure as that of the fuel cell 150 illustrated in FIG. 3 except the common singe solid electrolyte film 114.

Since the fuel cell 160 in accordance with the third embodiment is comprised of the unit cells, that is, the fuel cells 100 in accordance with the first embodiment, the fuel cell 160 has the advantages provided by the fuel cell 100 in accordance with the first embodiment.

Furthermore, since the fuel cell 160 has the reduced number of the solid electrolyte films 114 in comparison with the fuel cell 150 in accordance with the second embodiment, illustrated in FIG. 2, it is possible in the third embodiment to reduce the number of parts and simplify fabrication process.

### Fourth Embodiment

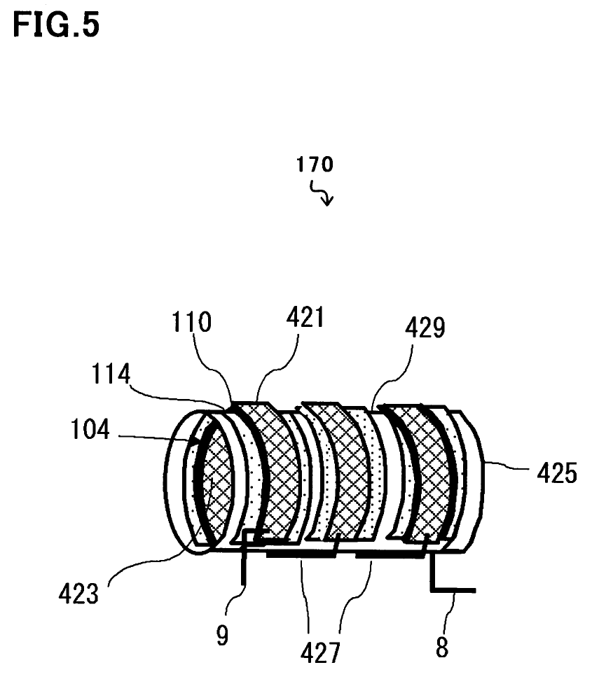

Still another example of a fuel cell comprised of a plurality of unit cells each comprised of the fuel cell 100 in accordance with the first embodiment, electrically connected to one another is illustrated in FIG. 5 as the fourth embodiment.

In the fuel cell 170 in accordance with the fourth embodiment, the fuel reservoir 425 is formed cylindrical. The unit cells each comprised of the fuel cell 100 in accordance with the first embodiment are arranged on outer and inner surfaces of the cylindrical fuel reservoir 425 such that the fuel electrodes 102 of the unit cells 100 make contact with the surfaces of the fuel reservoir 425.

Since the fuel cell 170 in accordance with the fourth embodiment is comprised of the unit cells, that is, the fuel cells 100 in accordance with the first embodiment, the fuel cell 170 has the advantages provided by the fuel cell 100 in accordance with the first embodiment.

Furthermore, since the unit cells 100 can be arranged in a smaller space than the fuel cell 150 in accordance with the second embodiment, illustrated in FIG. 3, and the fuel cell 160 in accordance with the third embodiment, illustrated in FIG. 4, it would be possible for the fuel cell 170 to increase output power per a unit area.

Though the unit cells 100 are arranged on both the outer and inner surfaces of the fuel reservoir 425 in the fuel cell 170 in accordance with the fourth embodiment, the unit cells 100 may be arranged one of the outer and inner surfaces of the fuel reservoir 425.

Similarly to the fuel cell 150 in accordance with the second embodiment, illustrated in FIG. 3, the unit cells 100 disposed adjacent to each other may be electrically connected to each other through the connection electrode 427.

Similarly to the fuel cell 160 in accordance with the third embodiment, illustrated in FIG. 4, a plurality of the unit cells 100 may be designed to commonly have a single solid electrolyte film 114.

Hereinbelow are explained some examples of the fuel cell 100 in accordance with the first embodiment.

### EXAMPLE 1

In Example 1, as carbon material of which the catalyst electrodes, that is, the fuel electrode 102 and the oxidizer electrode 108 (gas-diffusion electrode), there was used carbon paper having a thickness of 0.19 mm (commercially available from Tore).

As a porous metal plate of which the current-collectors 421 and 423 in the fuel and oxidizer electrodes 102 and 108 are comprised, there was used a titanium plate having a thickness of 0.3 mm. The titanium plate was formed uniformly with through-holes at a pitch (distance between centers of adjacent through-holes) of 1.5 mm, each having a diameter of 1 mm, in order to allow fuel and oxygen gas to pass therethrough. The titanium plate had a size of longitudinally and latitudinally 5 mm longer than the carbon paper in order to enable the external output terminals 8 and 9 to be electrically connected thereto.

The carbon paper and the titanium plate are thermally compression-bonded to each other by hot-pressing them at 10⁻⁵ Pa and at 1000 degrees centigrade for 10 minutes in a condition of being pressurized at about 10 kg/cm².

Observing a cross-section of the carbon paper and the titanium plate at the interface at which they were bonded to each other, by means of a scanning electron microscope, it was found out that there was uniformly formed a reaction layer having a thickness of about 10 nanometers, and that the carbon paper and the titanium plate were bonded to each other with sufficient high strength.

The catalyst layers 106 and 112 were formed on the surfaces of the carbon paper having been bonded to the titanium plate, as follows.

First, 5 wt. % naphyon alcohol solution commercially available from Aldrich Chemical was selected as solid polymer electrolyte, and then, the 5 wt. % naphyon alcohol solution was mixed and stirred with n-butyl acetate such that the concentration of the solid polymer electrode was in the range of 0.1 to 0.4 mg/cm³ both inclusive, to thereby have colloidal solution in which the solid polymer electrolyte was dispersed.

As catalyst for the fuel electrode 102, there were used carbon particulates (“Denka black” commercially available from Denki Kagaku) carrying at Pt—Ru alloy catalyst having a diameter in the range of 3 to 5 nanometers such that a weight ratio of the Pt—Ru alloy catalyst was 50%. As catalyst for the oxidizer electrode 108, there were used carbon particulates (“Denka black” commercially available from Denki Kagaku) carrying at Pt catalyst having a diameter in the range of 3 to 5 nanometers such that a weight ratio of the Pt—Ru alloy catalyst was 50%.

These carbon particulates were added to the colloidal solution of the solid polymer electrolyte, and were turned into paste by means of a super-sonic dispersion device. The solid polymer electrolyte and the catalyst were mixed with each other such that a weight ratio between them was 1:1. Then, the paste was coated onto the carbon paper at a density of 2 mg/cm² by screen-printing, and then, heated for drying the paste. Thus, there were fabricated the electrodes 102 and 108 used for the fuel cell.

These electrodes were hot-pressed on opposite surfaces of the solid electrolyte film 112 comprised of Naphyon commercially available from Du Pont, at 130 degrees centigrade at 10 kg/cm², to thereby fabricate the bonding structure 101 in which the catalyst electrodes and the solid electrolyte film were bonded to each other.

Then, the fuel reservoir 425 was caused to make close contact with the titanium plate defining the current-collector 421 of the fuel electrode in the bonding structure 101, and was sealed at a marginal portion thereof to the current-collector 421 with an adhesive. Thus, there was fabricated the fuel cell 100.

The fuel reservoir 425 was composed of aluminum, and was uniformly formed at a surface thereof at which the fuel reservoir 425 made contact with the current-collector 421 with a lot of apertures each having a diameter of 1 mm such that fuel could be introduced into the fuel electrode 102 through the apertures. The aperture ratio was 50%.

The external output terminals 8 and 9 were connected to the titanium plates of the fuel and oxidizer electrodes such that the fuel cell 100 could output power through the external output terminals.

The fuel reservoir 425 or a fuel channel for supplying fuel was arranged in contact with a surface of the current-collector 421 of the fuel electrode 102 in the fuel cell 100 such that fuel was supplied directly to a surface of the current-collector 421 of the fuel electrode 102. The current-collector 423 of the oxidizer 108 made direct contact at a surface thereof with atmosphere, and oxidizer was supplied directly to a surface of the current-collector 423 of the oxidizer electrode 108.

Since the substrates 104 and 110 were bonded to the current-collectors 421 and 423, respectively, in the fuel and oxidizer electrodes 102 and 108 in the fuel cell in accordance with Example 1, it was no longer necessary to use the end plates 120 and 122 (see FIG. 2) and the bolt and nut 13 for causing the substrates and the current-collectors to make close contact with each other. Thus, it was possible to supply fuel and oxidizer directly to the current-collectors 421 and 423 of the catalyst electrodes 102 and 108 at the surfaces of the current-collectors without the end plates 120 and 122. Accordingly, the fuel cell 100 could be fabricated thinner and lighter in weight.

As fuel, aqueous solution containing methyl alcohol at 10 v/v % was supplied to the fuel electrode 102, and oxygen was supplied to the oxidizer electrode 108.

Pouring liquid fuel into the fuel reservoir 425, the liquid fuel was supplied to the catalyst layer 106 of the fuel electrode 102 through the apertures of the fuel reservoir 425, the through-holes of the current-collector 421 comprised of a titanium plate, and the substrate 104 of the fuel electrode 102. In the oxidizer electrode 108, oxygen contained in atmosphere was supplied to the catalyst layer 112 of the oxidizer electrode 108 through the through-holes of the current-collector 423 comprised of a titanium plate, and the substrate 110 of the oxidizer electrode 108.

The flow rates of the fuel and oxidizer were 5 ml/min and 50 ml/min, respectively.

The output power of the fuel cell 100 was measured at 1 atom and at room temperature of 25 degrees centigrade. There was obtained 0.4V as output power at a current of 100 mA/cm².

Two fuel cell each in accordance with Example 1 were packed with an aluminum laminate film, and there was fabricated a fuel cell comprised of the two fuel cells electrically connected in series to each other. The resultant fuel cell output power of 0.8V at 100 mA/cm².

As mentioned above, a high-power characteristic was maintained in a fuel cell comprised of a plurality of the unit cells, that is, the fuel cells 100 each in accordance with the first embodiment, electrically connected to one another. Furthermore, such a fuel cell could be fabricated thin, small, and light-weighted.

### REFERENCE EXAMPLE 1

As a reference example 1, a bonding structure 101 in which catalyst electrodes and a solid electrolyte film were bonded to each other and which did not include the current-collectors 421 and 423 was fabricated in the same way as Example 1. In the same manner as a conventional fuel cell, that is, as illustrated in FIG. 2, the end plates 120 and 122 of the fuel and oxidizer electrodes 102 and 108 were pressurized by fastening them with a bolt and nut 13 for ensuring electrical contact therebetween, to thereby fabricate a fuel cell. The output characteristic of the thus fabricated fuel cell was measured in the same conditions as Example 1. As the end plates 120 and 122, there were used SUS 304 plates having a thickness of 1 mm and SUS 304 plates having a thickness of 0.3 mm.

When the end plates 120 and 122 had a thickness of 1 mm, there was obtained output of 0.36V at a current of 100 mA/cm² at 1 atom and at a room temperature of 25 degrees centigrade. When the end plates 120 and 122 had a thickness of 0.3 mm, there was obtained output of 0.2V at a current of 100 mA/cm².

When the end plates 120 and 122 having a thickness of 0.3 mm were used, the end plates 120 and 122 were deformed when fastened, because of insufficient rigidity of the end plates 120 and 122. Thus, the end plates 120 and 122 made insufficient electrical contact with the fuel and oxidizer electrodes 102 and 108, and a contact resistance therebetween was increased, resulting in reduction in output power of the fuel cell 100.

By comparing Example 1 and Reference Example 1 to each other, it was found out that it was possible to ensure sufficient electrical contact between the substrates and the current-collectors and to enhance output of the fuel cell 100 by bonding the carbon paper to the current-collectors 421 and 423, even if the titanium plate comprising the current-collectors 421 and 423 was thin, specifically, had a thickness of 0.3 mm.

Furthermore, since the fuel cell in accordance with Example 1 was not necessary to include the end plates 120 and 122 and a fastener 13 such as a bolt and nut, the fuel cell 100 could be fabricated thin, small, and light-weighted.

### EXAMPLE 2

There was used a carbon paper having a thickness of 0.19 mm (commercially available from Tore), as carbon material of which the catalyst electrodes, that is, the fuel and oxidizer electrodes (gas-diffusing electrodes) 102 and 108 were composed.

As a porous metal plate of which the current-collectors 421 and 423 of the fuel and oxidizer electrodes 102 and 108 were comprised, there was used a nickel plate having a thickness of 0.4 mm. The nickel plate was uniformly formed with through-holes at a pitch (distance between centers of adjacent through-holes) of 1.5 mm in order to allow oxygen gas to pass therethrough. Each of the through-holes had a diameter of 1 mm. The nickel plate had a size of longitudinally and latitudinally 3 mm longer than the carbon paper in order to enable the external output terminals 8 and 9 to be electrically connected thereto.

As brazing material, there was prepared paste comprised of palladium powder at 100 mg and alcoholic solvent at 10 ml.

The brazing material was coated onto a surface of the nickel plate at a thickness of about 10 micrometers, and then, the carbon paper was put on the coated brazing material. Then, the resultant was introduced into a vacuum furnace. The resultant was kept at 1200 degrees centigrade for 2 hours at a degree of vacuum equal to or smaller than 10⁻³ Pa, and then, was naturally cooled down in the vacuum furnace, to thereby bond the nickel plate to the carbon paper. As a result, the carbon paper and the nickel plate were bonded to each other with sufficiently high strength.

Similarly to Example 1, the catalyst layers 106 and 1112 of the fuel and oxidizer electrodes 102 and 108 were formed on the carbon paper having been bonded to the nickel plate, to thereby fabricate the electrodes 102 and 108.

These electrodes were hot-pressed on opposite surfaces of the solid electrolyte film 112 comprised of Naphyon commercially available from Du Pont, at 130 degrees centigrade at 10 kg/cm², to thereby fabricate the bonding structure 101 in which the catalyst electrodes and the solid electrolyte film were bonded to each other.

Then, the fuel reservoir 425 was caused to make close contact with the nickel plate defining the current-collector 421 of the fuel electrode 102 in the bonding structure 101, and was sealed at a marginal portion thereof to the current-collector 421 with an adhesive. There was used the same fuel reservoir 425 as the fuel reservoir used in Example 1.

The external output terminals 8 and 9 were connected to the nickel plates of the fuel and oxidizer electrodes 102 and 108 such that the fuel cell 100 could output power through the external output terminals.

The fuel cell in accordance with Example 2 has the same structure as that of Example 1. Specifically, the fuel reservoir 425 or a fuel channel for supplying fuel was arranged in contact with a surface of the current-collector 421 of the fuel electrode 102 such that fuel was supplied directly to a surface of the current-collector 421 of the fuel electrode 102. The current-collector 423 of the oxidizer 108 made direct contact at a surface thereof with atmosphere, and oxidizer was supplied directly to a surface of the current-collector 423 of the oxidizer electrode 108.

Pouring liquid fuel into the fuel reservoir 425, the liquid fuel was supplied to the catalyst layer 106 through the apertures of the fuel reservoir 425, the through-holes of the current-collector 421 comprised of a nickel plate, and the substrate 104 of the fuel electrode 102. In the oxidizer electrode 108, oxygen contained in atmosphere was supplied to the catalyst layer 112 of the oxidizer electrode 108 through the through-holes of the current-collector 423 comprised of a nickel plate, and the substrate 110 of the oxidizer electrode 108.

The output power of the fuel cell 100 in accordance with Example 2 was measured under the same conditions as those of Example 1. There was obtained 0.43V as output power.

### EXAMPLE 3

There was used a carbon paper having a thickness of 0.19 mm (commercially available from Tore), as carbon material of which the catalyst electrodes, that is, the fuel and oxidizer electrodes (gas-diffusing electrodes) 102 and 108 were composed.

As electrically conductive metal of which the current-collectors 421 and 423 of the fuel and oxidizer electrodes 102 and 108 were comprised, there was used a gold mesh having a thickness of 0.07 mm. A mesh size was 100 meshes.

Titanium was evaporated onto a surface of the gold mesh by a thickness of about 10 nanometers. The gold mesh had a size of longitudinally and latitudinally 3 mm longer than the carbon paper in order to enable the external output terminals 8 and 9 to be electrically connected thereto.

The gold mesh was placed on the carbon paper, and then, they were pressurized at 10 kg/cm² in a vacuum furnace to evacuate until a pressure in the furnace became 10⁻³ Pa or smaller. They were kept at 700 degrees centigrade for 2 hours, and then, were naturally cooled down in the vacuum furnace, to thereby bond the gold mesh to the carbon paper. As a result, the carbon paper and the gold mesh were bonded to each other with sufficiently high strength.

Similarly to Example 1, the catalyst layers 106 and 1112 of the fuel and oxidizer electrodes 102 and 108 were formed on the carbon paper having been bonded to the gold mesh, to thereby fabricate the electrodes 102 and 108.

These electrodes were hot-pressed on opposite surfaces of the solid electrolyte film 112 comprised of Naphyon commercially available from Du Pont, at 130 degrees centigrade at 10 kg/cm², to thereby fabricate the bonding structure 101 in which the catalyst electrodes and the solid electrolyte film were bonded to each other.

Then, the fuel reservoir 425 was caused to make close contact with the gold mesh defining the current-collector 421 of the fuel electrode in the bonding structure 101, and was sealed at a marginal portion thereof to the current-collector 421 with an adhesive, to thereby fabricate the unit cell 100. There was used the same fuel reservoir 425 as the fuel reservoir used in Example 1.

The external output terminals 8 and 9 were connected to the gold mesh of the fuel and oxidizer electrodes 102 and 108 such that the fuel cell 100 could output power through the external output terminals.

The fuel cell in accordance with Example 3 has the same structure as that of Example 1. Specifically, the fuel reservoir 425 or a fuel channel for supplying fuel was arranged in contact with a surface of the current-collector 421 of the fuel electrode 102 such that fuel was supplied directly to a surface of the current-collector 421 of the fuel electrode 102. The current-collector 423 of the oxidizer 108 made direct contact at a surface thereof with atmosphere, and oxidizer was supplied directly to a surface of the current-collector 423 of the oxidizer electrode 108.

Pouring liquid fuel into the fuel reservoir 425, the liquid fuel was supplied to the catalyst layer 106 through the apertures of the fuel reservoir 425, the through-holes of the current-collector 421 comprised of a gold mesh, and the substrate 104 of the fuel electrode 102. In the oxidizer electrode 108, oxygen contained in atmosphere was supplied to the catalyst layer 112 of the oxidizer electrode 108 through the through-holes of the current-collector 423 comprised of a gold mesh, and the substrate 110 of the oxidizer electrode 108.

The output power of the fuel cell 100 in accordance with Example 3 was measured under the same conditions as those of Example 1. There was obtained 0.42V as output power.

It was found out in light of the above-mentioned Examples and Reference Example that the end plates 120 and 122 and the fastener 13 were no longer necessary to use, and the fuel cell 100 could be fabricated small and light-weighted by using the catalyst electrodes 102 and 108 including the thin current-collectors 421 and 423. Furthermore, it was also found out that the fuel cell in accordance with Example 3 could not only be fabricated small and light-weighted, but also output higher power than a fuel cell including the end plates 120 and 122 and the fastener 13.

### INDUSTRIAL APPLICABILITY

As having been explained so far, the present invention makes it possible to fabricate a current-collector thin and light-weighted by bonding a substrate of a catalyst electrode to the current-collector, and thus, fabricate a fuel cell thin, small, and light-weighted, because it is no longer necessary to use end plates, and further, enable a fuel cell to output high power.

Hence, in accordance with the present invention, there is accomplished a fuel cell which outputs high power and is thin, small and light-weighted, by bonding a substrate of a catalyst electrode to a current-collector.

Furthermore, in accordance with the present invention, by designing fuel or oxidizer to be supplied directly to a current-collector of a fuel electrode or an oxidizer electrode, there is accomplished a fuel cell which is sufficiently small and light-weighted to be applied to a mobile terminal, and which has a high output density.

1. An electrode used for a fuel cell, comprising a substrate, a current-collector arranged on one of surfaces of said substrate, and a catalyst layer arranged on the other surface of said substrate,
characterized in that said current-collector and said substrate are bonded to each other.

2. The electrode used for a fuel cell as set forth in claim 1, wherein said substrate contains carbon as a principal component.

3. The electrode used for a fuel cell as set forth in claim 2, wherein said current-collector contains an element which will make carbide.

4. The electrode used for a fuel cell as set forth in claim 3, wherein said current-collector contains one or more element(s) selected from a group consisting of Ti, Zr, Hf, V, Nb, Ta, Cr, Mo, W, Mn, Fe, Co, Ni, Al and C.

5. The electrode used for a fuel cell as set forth in claim 1 or 2, wherein said current-collector contains one or more element(s) selected from a group consisting of Au, Ag, Cu and Pt.

6. The electrode used for a fuel cell as set forth in claim 1, 2 or 3, wherein said current-collector is comprised of a metal plate or a metal mesh.

7. The electrode used for a fuel cell as set forth in any one of claims 1 to 6, wherein said current-collector has a thickness equal to or greater than 0.05 mm, but equal to or smaller than 1 mm.

8. A fuel cell comprising a fuel electrode, an oxidizer electrode, and a solid electrolyte film sandwiched between said fuel electrode and said oxidizer electrode,
characterized in that one of said fuel electrode and said oxidizer electrode is comprised of an electrode defined in any one of claims 1 to 7.

9. The fuel cell as set forth in claim 8, wherein said fuel electrode is comprised of said electrode, and fuel is supplied directly to a surface of the current-collector of said electrode.

10. The fuel cell as set forth in claim 8, wherein said fuel electrode is comprised of said electrode, and further comprising a fuel reservoir or a fuel channel making contact with a surface of said current-collector of said electrode for supplying fuel to said fuel electrode.

11. The fuel cell as set forth in any one of claims 8 to 10, wherein said oxidizer electrode is comprised of said electrode, and an oxidizer is supplied directly to a surface of said current-collector of said electrode.

12. The fuel cell as set forth in any one of claims 8 to 11, wherein said current-collector of said electrode defining said oxidizer electrode makes direct contact at a surface thereof with atmosphere.

13. The fuel cell as set forth in any one of claims 8 to 11, further comprising a packing material with which said current-collector is packed at a surface thereof.

14. The fuel cell as set forth in any one of claims 8 to 13, wherein organic liquid fuel is supplied to said fuel electrode.

15. A fuel cell comprising a plurality of unit cells wherein unit cells disposed adjacent to each other are connected with one another through a connection electrode,
characterized in that each of said unit cells is comprised of a fuel cell defined in any one of claims 8 to 14.

16. The fuel cell as set forth in claim 15, wherein said plurality of unit cells have a common solid electrolyte film.

17. A fuel cell comprising a cylindrical fuel reservoir, and a plurality of unit cells,
characterized in that each of said unit cells is comprised of a fuel cell defined in any one of claims 8 and 11 to 14, and
said fuel electrode of each of said unit cells is arranged on at least one of outer and inner surfaces of said fuel reservoir.

18. The fuel cell as set forth in claim 17, further comprising a connection electrode through which unit cells disposed adjacent to each other are connected to each other.

19. The fuel cell as set forth in claim 18 or 19, wherein said plurality of unit cells have a common solid electrolyte film.

20. A method of fabricating a fuel cell comprising a substrate, a current-collector arranged on one of surfaces of said substrate, and a catalyst layer arranged on the other surface of said substrate, comprising:
a first step of coating a solution containing both particles containing solid polymer electrolyte and carbon particles carrying at catalyst, onto one of surfaces of said substrate for forming said catalyst layer; and
a second step of bonding said substrate at the other surface thereof to said current-collector.

21. The method as set forth in claim 20, wherein said substrate and said current-collector are bonded to each other by thermal compression in said second step.

22. The method as set forth in claim 20, wherein said substrate and said current-collector are bonded to each other by brazing in said second step.

23. The method as set forth in claim 22, wherein said substrate and said current-collector are bonded to each other by brazing in said second step through the use of one or more brazing metals selected from a group consisting of Pd, Fe, Ti, Ni, Zr, Cd and Al.

24. The method as set forth in claim 20, wherein said substrate contains carbon as a principle component, said current-collector contains metal, and said second step is comprised of a step of forming a bonding layer composed of metal carbide between said substrate and said current-collector.

25. The method as set forth in claim 24, wherein said bonding layer contains one or more elements selected from a group consisting of Ti, Zr, Hf, V, Nb, Ta, Cr, Mo, W, Mn, Fe, Co, Ni and Al.

26. A method of fabricating a fuel cell, comprising the steps of:
fabricating an electrode in accordance with the method defined in any one of claims 20 to 25; and
compressing said solid electrolyte film and said electrode to each other with said solid electrolyte film and said electrode being kept to make contact with each other, for bonding said solid electrolyte film and said electrode to each other.
